(19) United States
(12) Patent Application Publication
(10) Pub. No.: US 2014/0120209 A1
(43) Pub. Date: May 1, 2014

(54) EMULSION COMPRISING LYSO-PHOSPHOLIPIDS

(71) Applicant: NESTEC S.A, Vevey (CH)

(72) Inventors: Jean-Baptiste Bezelgues, Powell, OH (US); Pu-Sheng Cheng, Dublin, OH (US); Juan Sanz-Valero, Columbus, OH (US)

(73) Assignee: NESTEC S.A, Vevey (CH)

(21) Appl. No.: 14/127,086

(22) PCT Filed: Jun. 19, 2012
(86) PCT No.: PCT/EP2012/061635

§ 371 Date: Dec. 17, 2013

Related U.S. Application Data
(60) Provisional application No. 61/498,905, filed on Jun. 20, 2011.

(51) Int. Cl. A23C 11/10

(52) U.S. Cl. CPC A23C 11/106
USPC 426/7; 426/602; 426/590

(57) ABSTRACT

The present invention relates to an oil-in-water emulsion comprising a phospholipid emulsifier, the emulsifier comprising lyso-phospholipids, and methods of producing the emulsion. The emulsion is useful as a base for food and beverage products, e.g. coffee and tea creamers, and has good stability without the use of synthetic emulsifiers.

### FIELD OF THE INVENTION

The present invention relates to an oil-in-water emulsion comprising a phospholipid emulsifier, the emulsifier comprising lyso-phospholipids, and methods of producing the emulsion. The emulsion is useful as a base for food and beverage products, e.g. coffee and tea creamers, and have good stability without the use of synthetic emulsifiers.

### BACKGROUND

Many food and beverage products are based on oil-in-water emulsions. Emulsions are not thermodynamically stable, and to achieve the desired stability emulsifiers need to be used to stabilise the emulsions. The type and amount of emulsifier needed depend on many factors such as the chemical composition of the product, the amount of oil, the storage conditions and storage time. An example of products based on an oil-in-water emulsion is coffee and tea creamers. Many emulsifiers traditionally used in food and beverage products are synthetic. There is a wish to replace synthetic emulsifiers with emulsifiers of natural origin. Natural emulsifiers may e.g. be lecithins. Lecithins are phospholipid compositions, e.g. extracted from soya bean, rapeseed, sunflower or eggs. Lecithins are a mixture of complex polar lipids such as phosphatidylcholine (PC), phosphatidylethanolamine (PE), phosphatidylinositol (PI) and phosphatidic acid (PA). They are used in many food emulsions as emulsifying agents (e.g. sauce, ice cream) to create and disperse fine oil droplets in a continuous water phase. However, these lecithins do not always produce sufficient emulsion stability, e.g. in liquid coffee and tea creamers which are to be stored at ambient temperature. For certain applications, e.g. in baking, the emulsifying properties of lecithins are modified by enzymatic modification of the phospholipids, e.g. as disclosed in U.S. Pat. No. 4,034,124. However, there is still a need for emulsifiers derived from natural sources that provide good emulsion stability in liquid oil-in-water emulsions with up to 20% oil, such as e.g. certain coffee and tea creamer compositions.

### SUMMARY OF THE INVENTION

The inventors have found that a specific composition of phospholipids, which can be derived from natural lecithins by enzymatic treatment, provide superior emulsion stability in oil-in-water emulsions with up to 20% oil. Accordingly, the present invention relates to an oil-in-water emulsion comprising between 1% and 20% oil, and between 0.1% and 2% phospholipids (PL), wherein between 20% and 70% of the phospholipids are lyso-phospholipids (LPL).

### BRIEF DESCRIPTION OF THE DRAWINGS

FIG. 1 shows the emulsion stability obtained with different commercial lecithins w/wo enzymatic treatment with PLA2 that were used to replace the current emulsifiers (monoglycerides, DATEM) present in a liquid creamer, as described in example 1.

FIG. 2 shows emulsion stability of a typical creamer composition after 3 months of storage at 4° C., using different emulsifiers, as described in example 2.

FIG. 3 shows emulsion stability of a typical creamer composition tested after 3 months of storage at 4° C. The emulsifiers were canola lecithin with and without enzymatic treatment with PLA2. Details given in example 2.

FIG. 4 shows emulsion stability of a typical creamer composition using different emulsifiers, as described in example 3.

FIG. 5 shows emulsion stability of a typical creamer composition using different emulsifiers, as described in example 4.

### DETAILED DESCRIPTION OF THE INVENTION

The required type and amount of emulsifiers to stabilise an oil-in-water emulsion depends on the chemical composition of the emulsion, e.g. the amount of oil to be stabilised. The inventors have found that a specific composition of phospholipids is especially effective for stabilising an oil-in-water emulsion with between 1% and 20% (weight/weight) oil.

An oil-in-water emulsion of the invention comprises between 1% and 20% (weight/weight) oil, preferably between 5% and 10% (weight/weight) oil. The oil is preferably derived from animal and/or vegetable sources, most preferably from vegetable sources. Preferred vegetable sources are soya, canola, corn, sunflower, cotton seed, oat, and wheat. An oil-in-water emulsion according to the invention is preferably a liquid emulsion. By liquid is meant that the emulsion is liquid at ambient temperature, e.g. 20-25° C., so that it can be poured and/or consumed as a beverage, and/or added to, and dispersed in, a second liquid, e.g. a beverage. An oil-in-water emulsion according to the invention is preferably a food or beverage product, more preferably a liquid coffee and/or tea creamer intended to be added to a coffee or tea beverage to add whiteness, turbidity, flavour, and/or mouthfeel to the coffee or tea beverage.

The emulsion comprises between 0.1% and 2% (weight/weight) phospholipids (PL), preferably between 0.1% and 1% phospholipids. Between 20% and 70% (weight/weight) of the phospholipids are lyso-phospholipids (LPL), preferably between 30% and 70%, such as between 35% and 60% are LPL.

This oil-in-water emulsion has been found to have improved stability compared to similar oil-in-water emulsion containing a different mix of phospholipids. The oil-in-water emulsion is e.g. useful for the production of food and beverage products, e.g. for coffee and/or tea creamer products. The oil-in-water emulsion can be produced using natural phospholipids, e.g. derived from vegetable sources such as soya, canola sunflower, oat, and/or wheat.

In a preferred embodiment, between 15% and 50% (weight/weight) of the phospholipids in the oil in water emulsion are lyso-phosphatidylcholine (LPC), more preferably between 18% and 35% are LPC. Furthermore, it is preferred that maximum 25% (weight/weight) of the phospholipids are phosphatidylcholine (PC), and more preferred that between 10% and 20% of the phospholipids are phosphatidylcholine (PC). It is further preferred that between 10% and 40% (weight/weight) of the phospholipids are lyso-phosphatidylethanolamine (LPE), more preferably between 15% and 35% are LPE. Furthermore, it is preferred that maximum 18% (weight/weight) of the phospholipids are phosphatidylethanolamine (PE), more preferably maximum 16%. Preferably, less than 10% (weight/weight) of the phospholipids are lyso-phosphatidic-acid (LPA), more preferably less than 2%; and/or less than 10% (weight/weight) of the phospholipids are lyso-phosphatidylglycerol (LPG).

The phospholipids in the oil in water emulsion are preferably derived from a vegetable source, such as e.g. soy, canola, rapeseed, sunflower, wheat, and/or oat; and/or an animal source, e.g. egg. Phospholipids derived from soy and canola are commercially available, e.g. as soy lecithin and canola lecithin. Phospholipid compositions may e.g. be treated by fractionation to achieve the desired ratio of phospholipids. In a preferred embodiment, a phospholipid composition has been treated by hydrolysing phospholipids (PL) into lyso-phospholipids (LPL) to obtain the desired ratio of phospholipids for the oil in water emulsion of the invention, preferably the hydrolysis has been carried out by treating a phospholipid composition with an enzyme as described below.

### METHOD OF THE INVENTION

The invention further relates to a method of producing an oil-in-water emulsion described above. The method of the invention comprises providing a phospholipid composition. Phospholipid compositions obtained from natural sources, e.g. from animal or vegetable sources, normally comprises substantially no lyso-phospholipids, or only very low levels of lyso-phospholipids. A phospholipid composition to be used in the method of the invention may be provided from any suitable source, e.g. an animal source such as egg yolk, shrimp oil, krill oil or a vegetable source, such as soy, canola, wheat, rapeseed, sunflower, and/or oat.

To obtain the phospholipid composition to be used in the oil in water emulsion of the present invention from such a naturally occurring phospholipid composition, it is necessary to hydrolyse part of the phospholipids to produce lyso-phospholipids. The method of the invention thus comprises the steps of: a) providing a phospholipid composition; b) treating the phospholipid composition to hydrolyse one or more phospholipids to produce one or more lyso-phospholipids; and c) mixing the phospholipid composition with oil and water to produce an oil-in-water emulsion.

The hydrolysis step (step c)) of the method of the invention may be performed by any suitable method of hydrolysing phospholipids to produce lyso-phospholipids in the required amounts. The hydrolysis treatment may be performed before, during, and/or after mixing the phospholipid composition with oil and water to produce an oil-in-water emulsion. E.g. the phospholipid composition may be treated separately from the oil and water before the mixing in step c). In this case, if the treatment is done by an enzyme, the enzyme may e.g. be removed from the phospholipid composition, or inactivated, before the mixing in step c). The phospholipid composition may be mixed with water before the hydrolysis treatment. It is also possible to mix the phospholipid composition with oil and water to produce an oil-in-water emulsion before treating the composition to hydrolyse phospholipids. In a preferred embodiment, a phospholipid composition is treated with an enzyme in aqueous solution, e.g. at a phospholipid concentration of between 1% and 20% (weight/weight), before being mixed with additional water and oil to produce the oil-in-water emulsion. If the enzyme is a lipid acyltransferase, an acyl acceptor, such as e.g. sucrose and/or glucose, is preferably included in the aqueous solution. The enzyme is preferably inactivated by heat treatment before producing the emulsion. If the enzyme is immobilised, the enzyme is removed from the aqueous solution after treatment.

The mixing in step c) may be performed by any method suitable to mix a water phase, an oil phase and an emulsifier, to produce an oil-in-water emulsion. Such methods are well known in the art, and include intense stirring and homogenisation.

### Enzymes

The hydrolysis is preferably performed by treating the phospholipid composition obtained in step a) with an enzyme.

Enzymes to be used in the methods of the invention are capable of hydrolysing one or more phospholipids to produce lyso-phospholipids, e.g. capable of hydrolysing phosphatidylcholine (PC) to produce lyso-phosphatidylcholine (LPC), hydrolysing phosphatidylethanolamine (PE) to produce lyso-phosphatidylethanolamine (LPE), hydrolysing phosphatidic-acid (PA) to produce lyso-phosphatidic-acid (LPA), and/or hydrolyzing phosphatidylglycerol (PG) to produce lyso-phosphatidylglycerol (LPG). An enzyme to be used in the present invention preferably has substantially no, or low, phosphatidic acid and/or phosphatidylglycerol hydrolysing activity. Preferably, an enzyme to be used in the present invention has a high phospholipase activity.

Enzymes are preferably selected from the group consisting of phospholipase A1 (“PLA1”, EC 3.1.1.32), phospholipase A2 (“PLA2”, EC 3.1.1.4), lipid acyltransferase, and combinations thereof. EC (Enzyme Committee) numbers refer to the nomenclature of enzymes defined by the Nomenclature Committee of the International Union of Biochemistry and Molecular Biology (IUBMB).

A suitable PLA1 enzyme is e.g. LECITASE® Ultra (Novozymes, Bagsvaerd, Denmark).

A suitable PLA2 enzyme is e.g. MAXAPAL® A2 (DSM Food Specialties, Delft, the Netherlands).

A lipid acyltranferase is an enzyme that has acyltransferase activity (generally classified as EC 2.3.1.x), and catalyses the transfer of an acyl group from a lipid to an acyl acceptor, e.g. one or more of the following acyl acceptors: sterols; stanols; proteins; carbohydrates, e.g. sucrose and/or glucose; and sugar alcohols; to produce the corresponding ester. A lipid acyltransferase to be used in the methods of the present invention is preferably capable of transferring a fatty acid from a phospholipid to an acceptor, e.g. transferring a fatty acid in the sn-1 and/or the sn-2 position of the phospholipid to an acceptor. Preferably, the lipid acyltransferase to be used in the methods of the present invention has phosphatidylcholine acyltransferase activity, e.g. phosphatidylcholine-sterol-acyltransferase activity (EC 2.3.1.43); and/or phosphatidylethanolamine acyltransferase activity, but can also act on other phospholipids. The lipid acyltransferase may have PLA1 and/or PLA2 activity, the lipid acyltransferase may thus be capable of removing a fatty acid from a phospholipase even when no acceptor is available. A suitable lipid acyltransferase is e.g. KLM3′ disclosed in WO2011/061657A1 (Danisco A/S). Suitable commercial lipid acyltransferase preparations are e.g. FOODPRO® Cleanline and LYSO MAX® Oil, both available from Danisco A/S, Copenhagen, Denmark. A lipid acyltransferase to be used in the methods of the invention is preferably selected so that it is capable of using compounds present in the oil in water emulsion as acceptors. Alternatively, suitable acceptor compounds may be added to the oil-in water emulsion. In this way the formation of free fatty acids is avoided, which may otherwise affect the oxidation stability and taste of the oil-in-water emulsion. By using a lipid acyltransferase, it may be possible to use higher degrees of phospholipid conversion than would otherwise be possible, as the generation of fatty acids is reduced.

The enzyme may be in any suitable form and added in any suitable way. In one embodiment the enzyme is immobilised, allowing the enzyme to be removed from the composition after treatment and reused. Methods for immobilising enzymes are well known in the art, and any suitable method may be used.

### EXAMPLES

### Example 1

The enzymatic modification of phospholipids was evaluated to produce an emulsifier by using different commercial lecithin fractions, and emulsifying properties were compared to commercially available phospholipids fractions containing different initial amount and ratio of phospholipids. A commercial enzyme (MAXAPAL® A2, DSM Food Specialties, Delft, the Netherlands) classified as phospholipase A2 and derived from Aspergillus niger, was used in this study.

The commercial lecithins (5% W/W) were treated with PLA2 with a concentration of (0.2-2% w/w) for a period of time varying from 10 min to 6 h at 60° C.

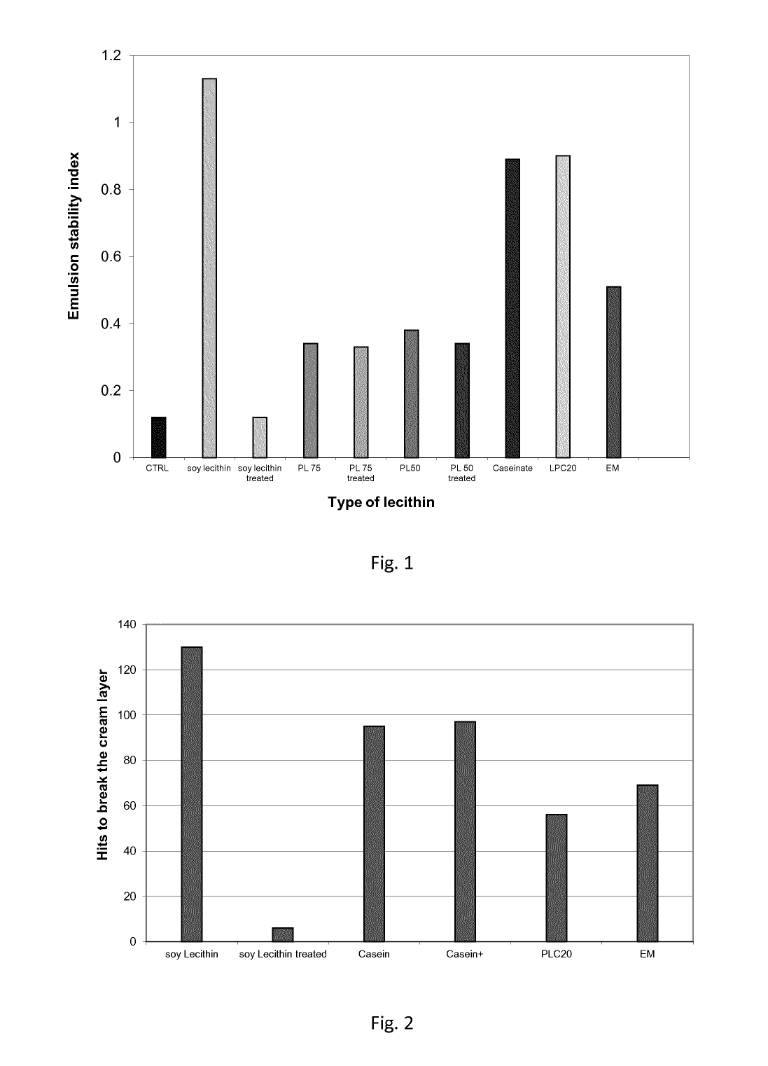

FIG. 1 shows the emulsion stability obtained with different commercial lecithins w/wo enzymatic treatment with PLA2 that were used to replace the current emulsifiers (monoglycerides, DATEM) present in a liquid creamer. Model emulsions were prepared by using water, oil (8.4%), sodium caseinate (0.9%) and emulsifier. The concentration of emulsifier (expressed in total lecithin content) present in the emulsion was 0.4% w/w. The emulsion stability was measured with a Turbiscan Lab at room temperature by monitoring over time the change in backscattering signal. Emulsion stability index were calculated for all the fractions. Interestingly among the different lecithins, enzymatically treated deoiled soy lecithin under the conditions described above produced similar emulsion stability compared to regular low molecular weight synthetic emulsifiers which are currently used in liquid coffee whiteners.

### Legend for FIG. 1:

CTRL: Control creamer sample produced with Monoglycerides/DATEM emulsifiers

Soy lecithin: Deoiled soybean lecithin, Alcolec F-100, American lecithin Company

Soy lecithin treated: Deoiled soybean lecithin treated with PLA2 as described above

PL 75: Fractionated soybean lecithin , Alcolec PC 75, American lecithin Company

PL75 treated: Fractionated soybean lecithin treated with PLA2 as described above

PL 50: Fractionated soybean lecithin, Alcolec PC50, American lecithin Company

PL 50 treated: Fractionated soybean lecithin treated with PLA2 as described above

LPC20: Commercial hydrolyzed canola lecithin, Alcolec C LPC 20, American lecithin Company

EM: Commercial hydrolyzed soybean lecithin, Alcolec EM, American lecithin Company.

### Example 2

Emulsion stability of a typical creamer composition was produced and tested after 3 months of storage at 4° C. The emulsifiers used in this recipe were different fractions of canola and soybean lecithin w/wo enzymatic treatment with PLA2.

The emulsion stability was tested by the following method:

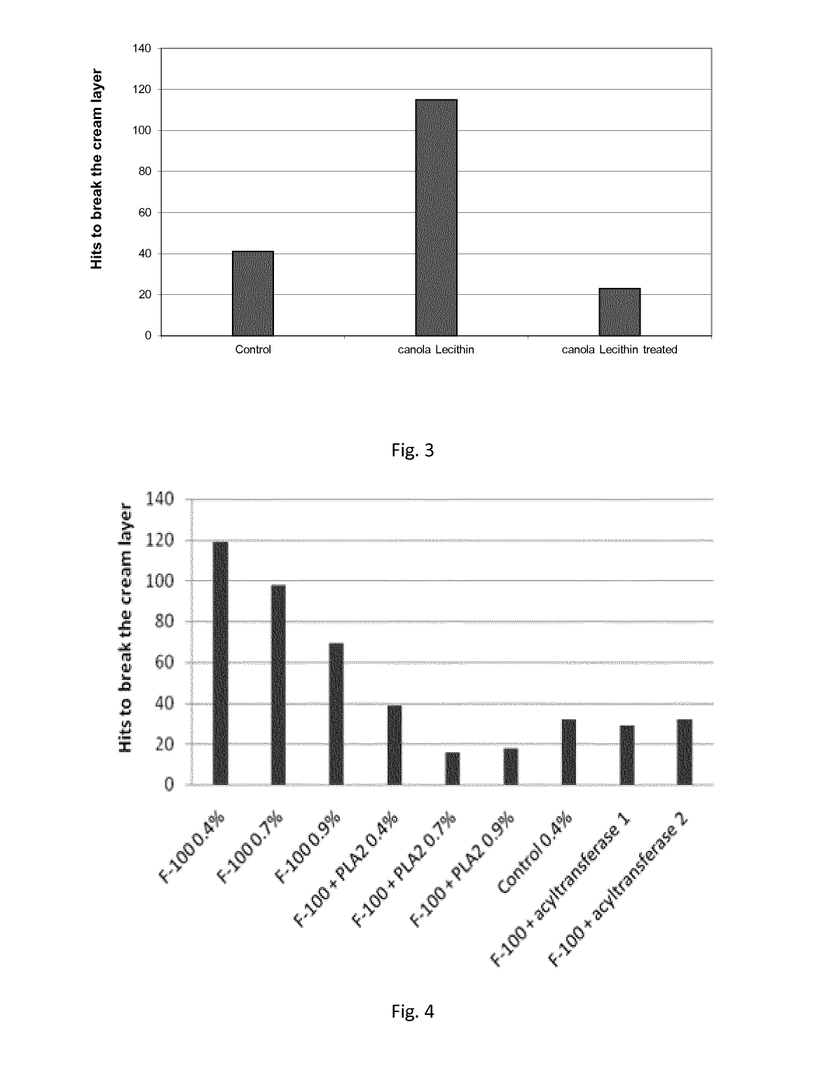

1. Samples were centrifuged at 25° C. (room temperature) at 4000 rpm for 2 hours to induce cream layer formation.
2. Samples were cooled in the tubes to 4-6° C. and centrifuged at this temperature for 1.5 h at 200 rpm to induce curd (plug) formation
3. Samples were hit upside down and the number of hits after which the ‘curd’ was destroyed was counted. Low hit numbers indicate the formation of a soft cream layer meaning that the overall stability of the emulsion is higher. High hit numbers indicate that the cream layer is harder because of partial crystallization due to partial coalescence of poorly stabilised oil droplets. Results in FIGS. 2 and 3 shows that the canola and soybean lecithin treated with PLA2 under the conditions described in example 1 show higher emulsion stability compared with the different commercial lecithin fractions.

The phospholipid composition of the soy and canola lecithin with and without (w/wo) treatment with PLA2 were analysed as follows.

The analysis of phospholipid and lyso-phospholipid content of the hydrolyzed lecithins was performed as follow:

Sample extraction: For each 5% lecithin sample, 2 mL of sample was extracted by adding 2 mL of methanol and 4 mL of chloroform. Samples were centrifugated for 5 min at 1000 RPM and the bottom layer was removed. The bottom layer was dried with nitrogen gas. The net weight was recorded and samples were re-suspended in Chloroform to a concentration of about 20 mg/mL and stored at −20 C until analysis. HPLC analysis: Each 5% lecithin extract was re-suspended in a 97:3 Toluene: Methanol solution to a concentration of 2 mg/mL. All samples were injected to a normal phase HPLC column and analyzed using an evaporative light scattering detector to identify neutral lipids. P NMR analysis: For each 5% lecithin extracts, quantitative P NMR analyses were performed on solutions prepared by drying down approximately 20 mg of extract with nitrogen gas and then re-suspending them in 2 mL of detergent. The phosphorous response obtained during the analysis was calibrated with a standard of dioleoyl phosphatidylcholine. The sample solutions were assayed at 512 scans for identification of different phospholipids by using standards.

The content of the following phospholipids were determined: phosphatidylcholine (PC), lyso-phosphatidylcholine (LPC), Phosphatidylinositol (PI), phosphatidylethanolamine (PE), lyso-phosphatidylethanolamine (LPE-1 and LPE-2), phosphatidic-acid (PA), lyso-phosphatidic-acid (LPA), and total lyso-phospholipids (total LPL). Results are given in table 1 below in percent by weight (weight/weight).

TABLE 1

| | | | | | | | | | Total |
|---|---|---|---|---|---|---|---|---|---|
| | PC | LPC | PI | PE | LPE-1 | LPE-2 | PA | LPA | LPL |
| Lecithin | (w/w) | (w/w) | (w/w) | (w/w) | (w/w) | (w/w) | (w/w) | (w/w) | (w/w) |
| F-100 | 36.91 | 1.51 | 17.67 | 32.42 | 2.17 | 0.00 | 8.26 | 0.00 | 3.68 |
| F-100 + | 16.63 | 20.18 | 17.55 | 10.10 | 22.46 | 1.58 | 9.88 | 0.00 | 44.22 |
| PLA2 | | | | | | | | | |
| C-20 | 40.80 | 3.45 | 19.71 | 26.24 | 1.85 | 0.00 | 7.05 | 0.00 | 5.30 |
| C-2 0 + | 18.28 | 27.87 | 15.41 | 14.14 | 15.62 | 1.60 | 7.08 | 0.00 | 45.09 |
| PLA2 | | | | | | | | | |

F-100: Deoiled soybean lecithin Alcolec F-100, American lecithin Company
F100 + PLA2: Deoiled soybean lecithin treated with PLA2 as described in example 1.
C-20: Deoiled canola lecithin, Alcolec C-20, American lecithin Company
C-20 + PLA2: Deoiled canola lecithin (Alcolec C-20, American lecithin Company) treated with PLA2 as described in example 1.

### Legend for FIGS. 2 and 3

Soy lecithin: Deoiled soybean lecithin Alcolec F-100, American lecithin Company

Soy lecithin treated: Deoiled soybean lecithin treated with PLA2 as described in example 1.

Casein: Creamer composition produced with only sodium caseinate used as emulsifier

Casein+: Creamer composition produced with only sodium caseinate used as emulsifier at higher concentration.

LPC 20: Commercial hydrolyzed canola lecithin, Alcolec C LPC 20, American lecithin Company

EM: Commercial hydrolyzed soybean lecithin, Alcolec EM, American lecithin Company

Control: Control creamer sample produced with Monoglycerides/DATEM from Danisco A/S, Copenahgen, Denmark

Canola lecithin: Deoiled canola lecithin, Alcolec C-20, American lecithin Company

Canola lecithin treated: Deoiled canola lecithin (Alcolec C-20, American lecithin Company) treated with PLA2 as described in example 1.

### Example 3

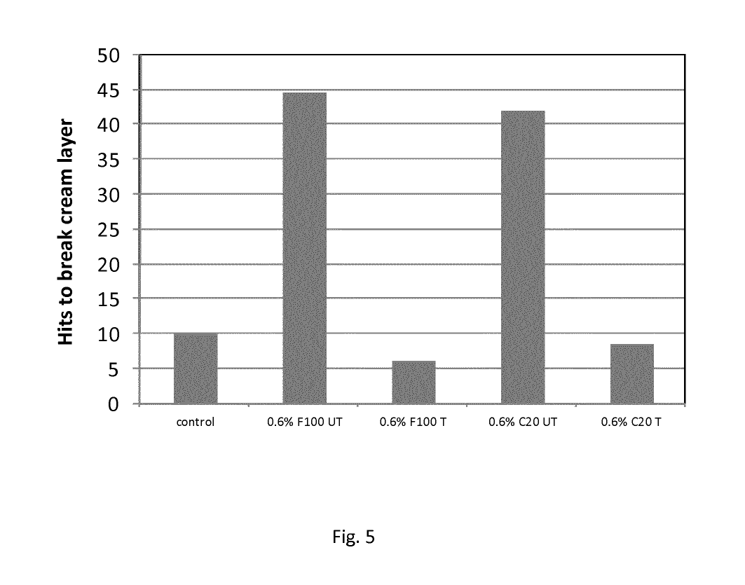

Creamer samples were produced as in example 2 using deoiled soy lecithin at different concentrations as emulsifier. The stability was tested as described in example 2. Results are shown in FIG. 4. Three enzymes were used in this study: A phospholipase A2 (MAXAPAL® A2, DSM Food Specialties, Delft, the Netherlands), and a two lipid acyltransferases (LysoMax Oil and FoodPro Cleanline from Danisco A/S, Copenhagen, Denmark). The lecithins were treated with PLA2 as described in example 1. When lecithin was treated with an acyltrasnferase the enzymatic reaction conditions were as follow: lecithin (5% w/w) and sucrose or glucose (5% w/w) as an acceptor were mixed with the enzyme (0.1-2% w/w) for a period of time varying from 10 min to 1 h at 45 C.

The results are given in FIG. 4. Higher emulsion stability was observed at higher lecithin concentration. Furthermore enzymatically treated lecithin with PLA2 provided higher stability compared to non-treated lecithin. Similar stability results were observed when the lecithin was treated with acyltranferase.

### Legend of FIG. 4

F-100 0.4%: Deoiled soybean lecithin at 0.4% (w/w), Alcolec F-100, American lecithin company

F-100 0.7%: Deoiled soybean lecithin at 0.7% (w/w), Alcolec F-100, American lecithin company

F-100 0.9%: Deoiled soybean lecithin at 0.9% (w/w), Alcolec F-100, American lecithin company

F-100+PLA2 0.4%: Deoiled soybean lecithin 0.4% w/w treated with PLA2 as described in example 1.

F-100+PLA2 0.7%: Deoiled soybean lecithin 0.7% w/w treated with PLA2 as described in example 1.

F-100+PLA2 0.9%: Deoiled soybean lecithin 0.9% w/w treated with PLA2 as described in example 1.

Control 0.4%: Control creamer sample produced with Monoglycerides/DATEM from Danisco A/S, Copenahgen, Denmark

F-100+acyltransferase 1: Deoiled soybean lecithin 0.4% w/w treated with acyltransferase Lysomax oil

F-100+acyltransferase2: Deoiled soybean lecithin 0.4% w/w treated with acyltransferase FoodPro Cleanline

### Example 4

Creamers containing different canola and soybean lecithin fractions (0.6% w/w) as emulsifier were produced w/wo enzymatic treatment with PLA2. The emulsion stability of these creamers was measured after 6 month of storage at 4° C. using the same methodology described in example 2.

Results in FIG. 5 shows that creamers containing canola and soybean lecithin treated with PLA2 as described in example 1 provide higher emulsion stability compared with creamers containing non treated commercial lecithins. Furthermore when creamer containing only non treated lecithin as emulsifier was added to hot coffee in a ratio 1:6 a physical destabilization of the product was observed in the form of free oil formation in cup.

### Legend for FIG. 5

0.6% F-100 UT: Deoiled soybean lecithin at 0.6% (w/w), Alcolec F-100, American lecithin company

0.6% F-100 T: Deoiled soybean lecithin Alcolec F-100 0.6% (w/w) treated with PLA2 as described in example 1.

0.6% C-20 UT: Deoiled canola lecithin at 0.6% (w/w), Alcolec C-20, American lecithin company

0.6% C-20 T: Deoiled soybean lecithin Alcolec C-20 0.6% (w/w) treated with PLA2 as described in example 1.

Control: Control creamer sample produced with Monoglycerides/DATEM (0.4% w/w) from Danisco A/S, Copenahgen, Denmark.

1. An oil-in-water emulsion comprising 1% to 20% oil, between 0.1% to 2% phospholipids (PL), wherein 20% to 70% of the phospholipids are lyso-phospholipids (LPL).

2. The oil-in-water emulsion of claim 1, wherein 15% to 50% of the phospholipids are lyso-phosphatidylcholine (LPC).

3. The oil-in-water emulsion of claim 1, wherein 10% to 40% of the phospholipids are lyso-phosphatidylethanolamine (LPE).

4. The oil-in-water emulsion of claim 1, wherein less than 10% of the phospholipids are lyso-phosphatidic-acid (LPA).

5. The oil-in-water emulsion of claim 1, wherein less than 10% of the phospholipids are lyso-phosphatidylglycerol (LPG).

6. The oil-in-water emulsion of claim 1, wherein no more than 25% of the phospholipids are phosphatidylcholine (PC).

7. The oil-in-water emulsion of claim 1, wherein less than 18% of the phospholipids are phosphatidylethanolamine (PE).

8. The oil-in-water emulsion of claim 1 comprising 1% to 60% sugar.

9. The oil-in-water emulsion of claim 1, wherein the emulsion is a food or beverage product.

10. The oil-in-water emulsion of claim 9, wherein the emulsion is a coffee or tea creamer.

11. A method of producing an oil-in-water emulsion comprising:
providing a phospholipid composition;
treating the phospholipid composition to hydrolyse one or more phospholipids to produce one or more lyso-phospholipids; and
mixing the phospholipid composition with oil and water to produce an oil-in-water emulsion comprising 1% to 20% oil, and 0.1% to 2% phospholipids (PL), wherein 20% to 70% of the phospholipids are lyso-phospholipids (LPL).

12. The method of claim 11 wherein the treating step is performed before, during, and/or after the mixing step.

13. The method of claim 11, wherein the treating step is performed by treating the phospholipid composition with an enzyme.

14. The method of claim 13, wherein the treating step is performed by treating the phospholipid composition with an enzyme selected from the group consisting of phospholipase A1 (PLA1, EC 3.1.1.32), phospholipase A2 (PLA2, EC 3.1.1.4), lipid acyltransferase, and combinations thereof.
